(19) United States
(12) Patent Application Publication
(10) Pub. No.: US 2010/0304079 A1
(43) Pub. Date: Dec. 2, 2010

(54) END CAP STRUCTURE OF A LED LAMP TUBE

(76) Inventors: Mei-Ling YANG, Chung He City (TW); Cheng-Hsun WU, Chung He City (TW)

Correspondence Address: LEONG C. LEI, PMB # 1008, 1839 YGNACIO VALLEY ROAD, WALNUT CREEK, CA, 94598, US

(21) Appl. No.: 12/472,394

(22) Filed: May 27, 2009

(51) Int. Cl. B32B 3/06

(52) U.S. Cl. 428/99

(57) ABSTRACT

An end cap mounting structure includes an end cap for capping on one end of a tube for LED lamp tube, a locating plate fixedly mounted inside the end cap, two metal contacts fixedly connected to the locating plate and respectively extended out of the end cap through a respective through hole on the end cap, two gaskets respectively attached to the metal contacts and set in the through holes of the end cap to seal the gap between the through holes and the metal contacts, an insert press-fitted into the end cap and stopped against the locating plate, a cushion pad set in the end cap between the insert and the locating plate, a self-tapping screw driven through the insert, the cushion pad and the locating plate into the end cap to affix the insert, the cushion pad, the locating plate and the end cap together.

### BACKGROUND OF THE INVENTION

(a) Technical Field of the Invention

The present invention relates to a LED lamps and more particularly to the end cap mounting structure for LED lamp tube, which effectively prevents retraction of the metal contacts upon an accidental impact.

(b) Description of the Prior Art

Before the invention of “power-saving lamps”, people usually use tungsten lamp bulbs or fluorescent lamp bulbs for illumination. Because tungsten lamp bulbs have the drawback of high waste heat and high energy consumption, fluorescent lamp bulbs are preferably selected for home use or for use in business places where a big amount of electric power is consumed. Following the trends in energy saving and environmental protection practices, power-saving lamps become more and more popularly accepted. Nowadays, LEDs (light emitting diodes) have been intensively used in our daily life for the advantages of small size and low power consumption. Following fast development in LED technology, LEDs have been intensively used in many different fields, including indoor lighting, outdoor lighting, traffic lighting and signaling, outdoor advertising, and etc.

Basically, a LED comprises an electroluminescent semiconductor material located on a rack with lead wires and packaged with epoxy resin. Many LED lamps are commercially available. These commercial LED lamps have different configurations. Some commercial LED lamps have the shape of a fluorescent lamp tube.

A known LED lamp tube, as shown in FIG. 6, comprises a light transmissive lamp tube 1, which may be molded from transparent plastics, a circuit board 11 mounted in the light transmissive lamp tube 1 and carrying a plurality of LEDs 111, and two end caps 2 respectively affixed to the two ends of the light transmissive lamp tube 1 with an adhesive or by means of a hook joint. Each end cap 2 carries two metal contacts 23 that are electrically connected to the circuit board 11. When electricity is connected to the LEDs 111 at the circuit board 11 through the metal contacts 23, the LEDs 111 are driven to emit light. According to this design, the mounting arrangement between the metal contacts 23 and the associating end cap 2 is done by means of: affixing the metal contacts 23 to a contact holder plate 22, and then inserting the metal contacts 23 through respective through holes on the end cap 2, and then fixedly fastening the contact holder plate 22 inside wall of the end cap 2, and then affixing a gasket pad 24 to the outside wall of the end cap 2 to seal the gap between the metal contacts 23 and the through holes of the end cap 2.

Further, because LED lamp tubes have gained popularity in recent years, the examination of related product safety is becoming more critical. The said examination includes impact test. When performing an impact test, the whole LED lamp tube product is dropped freely from a predetermined height. After free fall, the damage status of the LED lamp tube is examined. Because the tubes and end caps of regular LED lamp tubes are molded from plastics, they do not break when dropped from a high place. The related safety standards allow a certain status of deformation of the metal contacts after an impact. However, the related safety standards do not allow retraction of the metal contacts into the inside of the end caps because such a retraction may result in electrical safety problems, such as electric leakage or short circuit.

According to the aforesaid prior art design, the contact holder plate 22 prevents the metal contacts 23 from escaping out of the associating end cap 2, however, the contact holder plate 22 cannot prohibits the metal contacts 23 from being forced axially backwardly to the inside of the associating end cap 2 by accident. Therefore, this prior art design has a high defective rate when examined through an impact test.

### SUMMARY OF TUE INVENTION

The present invention has been accomplished under the circumstances in view. It is one object of the present invention to provide an end cap mounting structure for LED lamp tube, which effectively prevents retraction of metal contacts into the inside of the end cap upon an impact, assuring a high level of product safety.

To achieve this and other objects of the present invention, an end cap mounting structure for LED lamp tube comprises an end cap for capping on one end of a tube for LED lamp tube, a locating plate fixedly mounted inside the end cap, two metal contacts fixedly connected to the locating plate and respectively extended out of the end cap through a respective through hole on the end cap, two gaskets respectively attached to the metal contacts and set in the through holes of the end cap to seal the gap between the through holes and the metal contacts, an insert press-fitted into the end cap and stopped against the locating plate, a cushion pad set in the end cap between the insert and the locating plate, a self-tapping screw driven through the insert, the cushion pad and the locating plate into the end cap to affix the insert, the cushion pad, the locating plate and the end cap together.

Further, two cushion pads are respectively attached to the metal contacts and set between the end cap and the gaskets, enhancing shock absorbing action of the end cap mounting structure upon an accidental impact.

### SUMMARY OF THE INVENTION

The primary purpose of the present invention is to provide an end cap mounting structure for LED lamp tube, which effectively prevents retraction of metal contacts into the inside of the end cap upon an impact, assuring a high level of product safety.

To achieve this and other objects of the present invention, an end cap mounting structure for LED lamp tube comprises an end cap for capping on one end of a tube for LED lamp tube, a locating plate fixedly mounted inside the end cap, two metal contacts fixedly connected to the locating plate and respectively extended out of the end cap through a respective through hole on the end cap, two gaskets respectively attached to the metal contacts and set in the through holes of the end cap to seal the gap between the through holes and the metal contacts, an insert press-fitted into the end cap and stopped against the locating plate, a cushion pad set in the end cap between the insert and the locating plate, a self-tapping screw driven through the insert, the cushion pad and the locating plate into the end cap to affix the insert, the cushion pad, the locating plate and the end cap together.

Further, two cushion pads are respectively attached to the metal contacts and set between the end cap and the gaskets, enhancing shock absorbing action of the end cap mounting structure upon an accidental impact.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an end cap mounting structure for LED lamp tube in accordance with a first embodiment of the present invention.

FIG. 2 is a sectional exploded side view of the end cap mounting structure for LED lamp tube in accordance with the first embodiment of the present invention.

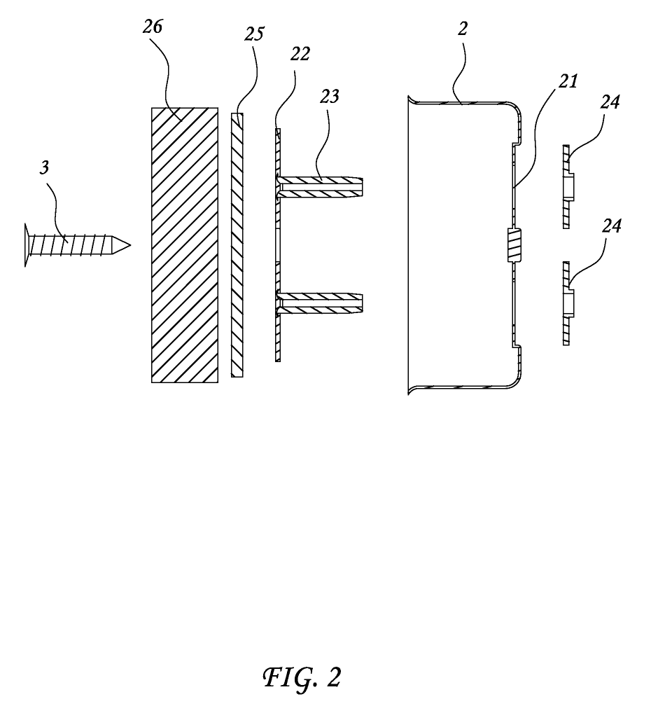

FIG. 3 is a sectional assembly view of the end cap mounting structure for LED lamp tube in accordance with the first embodiment of the present invention.

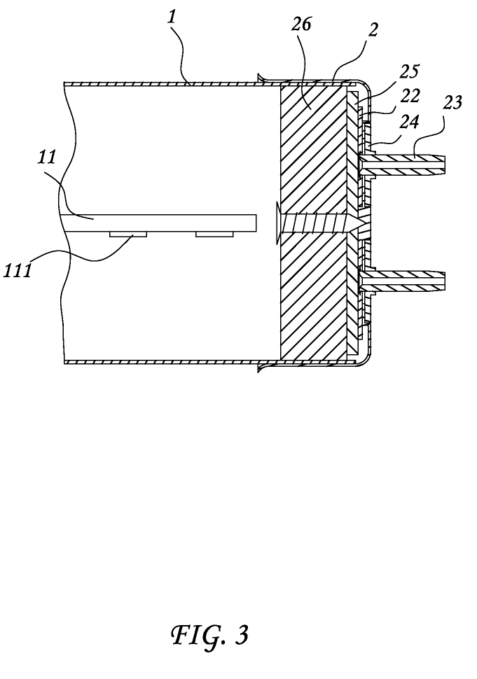

FIG. 4 is an exploded side view of an end cap mounting structure for LED lamp tube in accordance with a second embodiment of the present invention.

FIG. 5 is a sectional exploded side view of the end cap mounting structure for LED lamp tube in accordance with the second embodiment of the present invention.

FIG. 6 is a sectional assembly view of the end cap mounting structure for LED lamp tube in accordance with the second embodiment of the present invention.

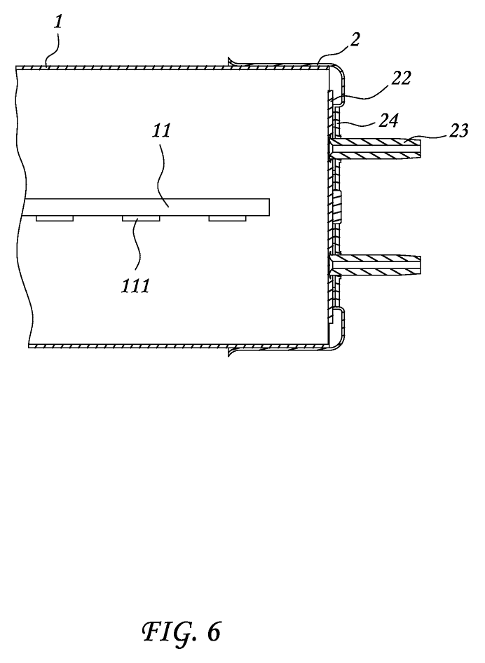

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

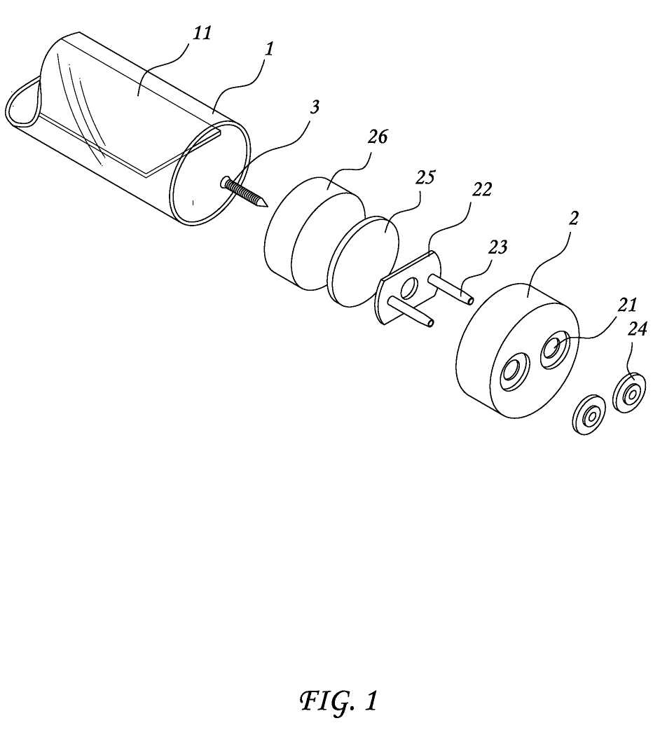

Referring to FIGS. 1˜3, a LED lamp tube is shown comprising a lamp tube 1 and two end caps 2.

The lamp tube 1 is a light transmissive tube, carrying a LED module therein. The LED module comprises a circuit board 11 and a plurality of LEDs (light emitting diodes) 111 installed in the circuit board 11. The two end caps 2 are respectively capped on the two distal ends of the lamp tube 1. Because the mounting structures between the two ends of the lamp tube 1 and two end caps 2 are identical, only one end cap mounting structure is described hereinafter for understanding.

As illustrated, the end cap 2 holds two metal contacts 23 that are electrically connected to the circuit board 11 by lead wires (not shown). The two metal contacts 23 are fixedly riveted to a locating plate 22. The end cap 2 has two countersunk holes 21 for the passing of the metal contacts 23 respectively. After insertion of the metal contacts 23 through the countersunk holes 21 of the end cap 2, the locating plate 22 is fixedly fastened to the inside of the end cap 2 by soldering or with screws. Thereafter, a cushion pad 25 is inserted into the inside of the end cap 2 and stopped against the locating plate 22, and then an insert 26 is press-fitted into the inside of the end cap 2 and stopped against one side of the cushion pad 25 opposite to the locating plate 22. Thereafter, a self-tapping screw 3 is driven through the insert 26, the cushion pad 25 and the locating plate 22 into the end cap 2 to affix the insert 26 to the end cap 2. Further, two gaskets 24 are respectively attached to the metal contacts 23 and fitted into the countersunk holes 21 to seal the gap between the countersunk holes 21 and the metal contacts 23.

As stated above, there is a cushion pad 25 set between the locating plate 22 and the insert 26. The cushion pad 25 absorbs shocks from the metal contacts 23 upon an accidental impact. However, the cushion pad 25 may be omitted, enabling the locating plate 22 to be directly sandwiched between the end cap 2 and the insert 26. This arrangement is sufficient to stop the metal contacts 23 from backward displacement relative to the end cap 2 upon an accidental impact.

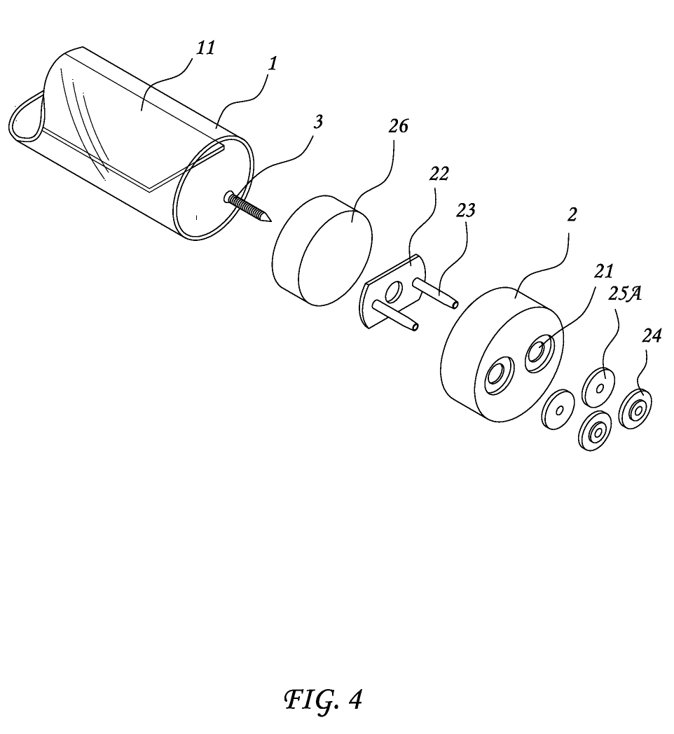

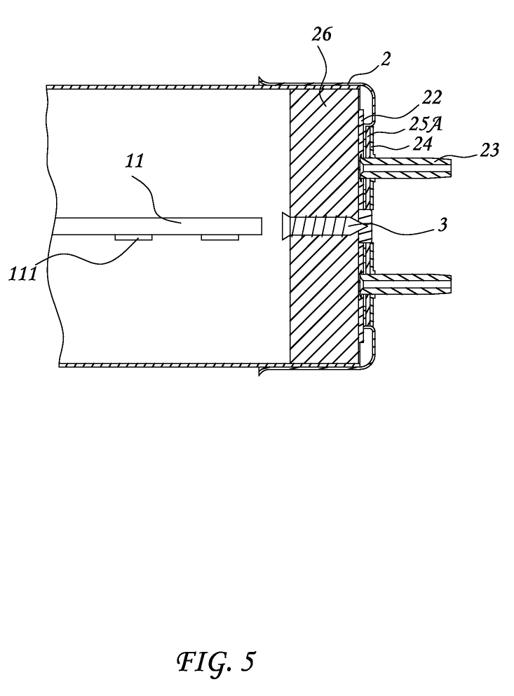

FIGS. 4 and 5 show an alternate form of the present invention. This alternate form is substantially similar to that shown in FIGS. 1˜3 with the exception of the added cushion pads 25A. The cushion pads 25A are respectively attached to the metal contacts 23 and set in the countersunk holes 21 and stopped between the end cap 2 and the two gaskets 24.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An end cap mounting structure, comprising an end cap for capping on one end of a tube for LED lamp tube, said end cap having two through holes, a locating plate fixedly mounted inside said end cap, said locating plate having a first side kept in contact with an inside wall of said end cap and a second side opposite to said first side, two metal contacts fixedly connected to the first side of said locating plate and respectively extended out of said end cap through said through holes, and two gaskets respectively attached to said metal contacts and set in said through holes to seal the gap between said through holes and said metal contacts, wherein the end cap mounting structure further comprises an insert press-fitted into said end cap and stopped against the second side of said locating plate, and fastening means to affix said insert to said locating plate and said end cap.

2. The end cap mounting structure as claimed in claim 1, further comprising a cushion pad set inside said end cap between said insert and said locating plate.

3. The end cap mounting structure as claimed in claim 1, further comprising two cushion pads respectively attached to said metal contacts and set between said end cap and said gaskets.

4. The end cap mounting structure as claimed in claim 1, wherein said fastening means is a self-tapping screw.
